(19) United States
(12) Patent Application Publication
(10) Pub. No.: US 2001/0006520 A1
(43) Pub. Date: Jul. 5, 2001

(54) Data Communications

(75) Inventors: Timothy J. Moulsley, Caterham (GB); Edward S. Eilley, Reigate (GB)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(73) Assignee: U.S. PHILIPS CORPORATION

(21) Appl. No.: 09/745,855

(22) Filed: Dec. 22, 2000

(30) Foreign Application Priority Data
Dec. 24, 1999 (GB) 9930849.6

(51) Int. Cl. H04Q 11/00

(52) U.S. Cl. 370/364

(57) ABSTRACT

A method of communicating data from a data source (10) on one bus system (1) to a data sink (30) on another bus system (3) whose cycle rate is similar to but not synchronised with that of the first bus system comprises the steps of determining the tolerances with respect to frequency between the first and second bus cycle periods, assembling the data for transmission into packets, allocating a variable size, dependent on the tolerances, data payload to the packets, and including within the packets a header indicating the size of the payload. The receiving bus (3) receives these packets and extracts the data payload from the packets using the packet header indication of the size of the data payload.

The invention relates to a method of communicating isochronous data from a source attached to a first serial bus to a sink attached to a second serial bus. The invention further relates to a communications system operating according to the method and to a data a bus arrangement.

Isochronous data streams have the requirement that they must flow substantially steadily, usually because they comprise data that will be used by applications that present information in real time. Buses have advantages in certain kinds of environments and patterns of use: they offer flexibility of connection and utilisation of the communication capacity. This flexibility tends to conflict with the requirements of isochronous streams.

A known resolution of this problem is to arrange that the time on such a bus has a rhythm in the form of a cycle or frame structure. Then a satisfactory approximation to the steady flow can be achieved by arranging that a suitably sized block of information is offered to the bus in each frame or cycle. Ideally, the size of this block should be exactly constant but the unpredictability of stream data rates and the need to dimension the blocks in terms of bits, bytes or even larger data units usually precludes this. In practice, therefore, there may be some small variability in the size of the data block from cycle to cycle but the jitter introduced thereby can usually be smoothed by simple means.

For the purposes of management of the bus itself, it is usual to add headers and, if data verification is required, trailers to the data blocks. In this form the bundle of data is usually called a packet. For connection between pieces of equipment, buses that operate in a bit serial mode have the advantage that the connecting cables have few separate conductors. The wired buses that find favour in application areas for which isochronous transmission is important tend to be of this type and operate at high speed. Equivalent wireless networks also use bit serial transmission.

The communication of an isochronous stream over one such serial bus is straightforward. The bandwidth required for the source stream is translated into a packet payload size for every bus cycle so that the product of payload size and cycle rate is the stream rate, with allowance for packet overhead and, perhaps, some rounding to deal with discrete data unit sizes. Then arrangements are made to ensure that the corresponding space is available on the bus in each cycle. The packets are offered to the bus cycle after cycle by the sending device or source and retrieved by the target device or sink where the original stream is reconstituted.

More complicated networks can, in principle, be made by linking several such buses together. The links, which connect interface devices on each of the buses, may be within an enclosure that contains both of the participating interface nodes or they may be, in their own right, parts of other communication network arrangements which could span significant distances. Ideally and at either extreme, these would be invisible to the entities that control the internal operation of the buses themselves.

If such networks of buses are to support the carriage of isochronous streams all the elements of the end-to-end connection must offer the same total guaranteed bandwidth and must also be able to manage the packet and cycle or frame structure. A known solution to this is to require that the “rhythms” of all the buses involved are synchronised so that the packets naturally pass through the network with the proper regularity. Such synchronisation is, however, not a simple task.

It is an object of the invention to enable the communication of isochronous data between a source on one serial data bus and a sink on a different serial data bus having a similar cycle period to the first data bus without requiring the two buses to be synchronised.

The invention provides a method of communicating isochronous data from a source attached to a first serial bus to a sink attached to a second serial bus, said first and second buses operating cyclically with similar but unsynchronised cycle periods, the method comprising the steps of determining the tolerances with respect to frequency between the first and second bus cycle periods, assembling the data for transmission into packets, allocating to said packets a variable size data payload dependent on the tolerances, including within the packets a header indicating the size of the payload, receiving the packets at the data sink, and extracting the data payload from the packets using the packet header indication of the size of the data payload.

The invention is based on the realisation that even if synchronisation is not achieved, it can be ensured that all the data is passed between the buses by taking into account the maximum tolerances of the cycle rates of the various buses and making the maximum data transfer rate such that the packet data pay load can accommodate the slowest bus. This means that the data payload for faster buses is not fully utilised but if the disparity in cycle rates is small, for example when two or more IEEE 1394 buses are interconnected, then the loss of data transfer capacity is small. It should be noted that the reference is IEEE 1394 is purely exemplary and that the present invention is equally applicable to other bus systems, both wired and wireless.

The method may further comprise the steps of receiving data packets transmitted from the first bus at the second bus, entering the received packets into a received packets register, transferring each received packet into a first in first out (FIFO) memory when sufficient space exists in said FIFO memory, reading out output data packets from said FIFO memory at the cycle rate of the second bus, said output packets containing a data payload which is chosen to keep the average contents of the FIFO memory substantially constant.

In this way the data packets are transmitted to target devices as sinks attached to the second bus. The assembled data packets are transmitted on the second bus at a rate dependent on the cycle rate of the second bus. The size of the data payload is adjusted to keep the contents of the FIFO as near constant as possible and, as a result, within the target device or sink the average rate of receiving the data will be the same as the average rate of the data sent by the sending device or source on the first bus.

The method may comprise the further step of including in the data payload a code indicating the end of the data contained within the received packet whose data payload forms the initial part of the data payload of the output data packet.

The method may comprise the steps of receiving output data packets from the second bus, reassembling them into data packets as received from the first bus, and transmitting the reassembled packets to a third bus operating cyclically with similar cycle periods to the first and second buses but not being synchronised with either of the other buses.

By including a code indicating the end of a data payload as received from another bus it is possible to ensure that on transmission to a further bus the data packets can be reassembled to be identical to those received from the first bus. Consequently, the bus containing the sending device defines the data packet that is transferred from bus to bus where more than two buses are interconnected. Therefor transfer of data between data buses is always by means of data packets identical to those placed on the first bus.

The method may include the step of inserting into the data payload of the output data packet a code indicating the length of the data payload of data received in a received data packet subsequent to the received data packet whose data payload occupies the initial portion of the data payload of the output data packet.

This measure will assist the maintenance of continuity if a packet is lost. Thus the original packet boundaries may be preserved in the event of a one packet loss although the data damage cannot be prevented by this means. That is the lost data packet remains lost and the data cannot be recaptured without further measures being taken.

The invention further provides communications network for communicating isochronous data comprising first and second buses, one or more data sources connected to the first data bus, one or more data sinks connected to the second data bus for receiving isochronous data from the data source, each data bus having similar but unsynchronised cycle periods said communications network further comprising a first interface arrangement connected to said first bus, said first interface arrangement comprising a packet assembly arrangement which assembles at the cycle rate of the first bus data packets comprising a header portion and a data payload portion, the header portion including data defining the length of the payload portion, and an output from which the data packets can be transmitted to a second interface arrangement connected to said second bus, said second interface arrangement comprising a buffer memory arrangement which receives the data packets sent by the first interface arrangement, separates the data payload from the data packet, reassembles data packets at the cycle rate of the second bus in such a manner that the quantity of data in the buffer memory kept substantially constant by varying the quantity of data in the payload of the data packet, and applies the reassembled data packets to the second bus.

The second interface arrangement may comprise means for inserting data, which defines the end of the data payload of the received data packet which occupies the first part of the data payload of the reassembled packet, into the reassembled data packet within the data payload of the reassembled data packet.

This enables the data packets transferred from one bus via an intermediate bus to a third bus to appear at the third bus in the same form as sent from the first bus.

The second interface arrangement may further insert data representing the length of the data payload of the next received packet.

This results in the possibility of reconstructing the original packet boundaries if one packet is lost. It will not, however, enable reconstitution of the lost packet.

The communication network may comprise a third interface arrangement arranged to receive data packets from said second bus for transfer to a third bus, said third interface arrangement comprising a packet received register for receiving data packets from the second bus, a FIFO into which the received packets are transferred when space is available for them, and a packet reassembler which uses the data indicating the end of received packets to reassemble for transfer to the third bus data packets identical to the data packets transmitted from the first bus.

This means that the interface arrangements on the second bus produce a transparent transfer of data packets between the first and third buses.

The above and other features and advantages of the invention will be apparent from the following description, by way of example of an embodiment of the invention with reference to the accompanying drawings, in which:

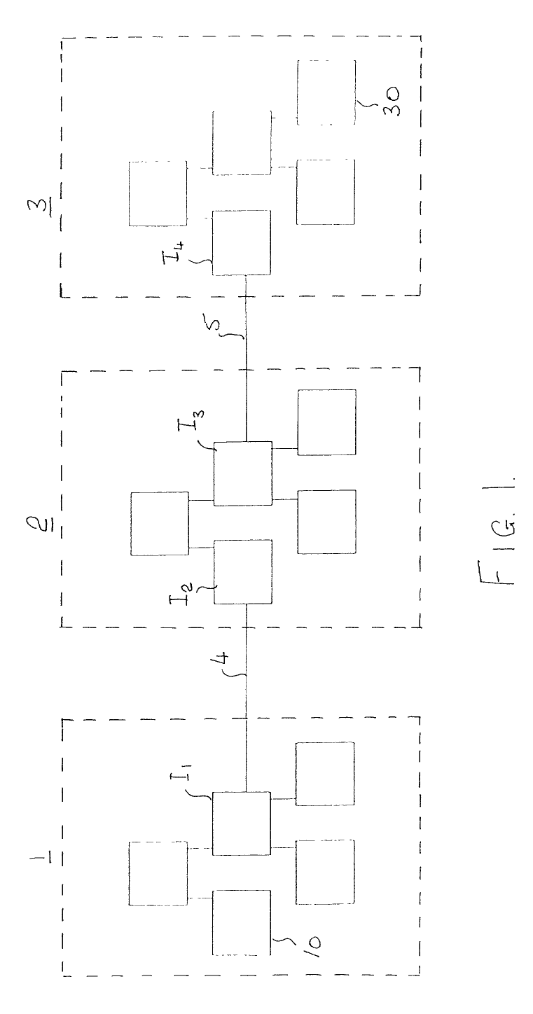

FIG. 1 shows in block schematic form a network of interconnected bus systems according to the invention,

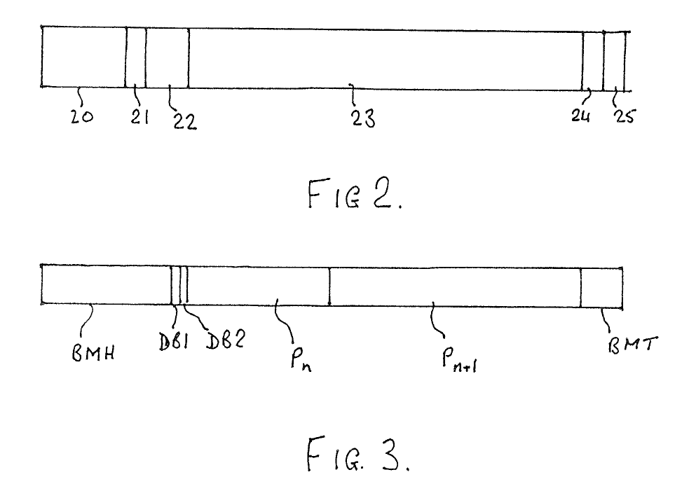

FIG. 2 shows a typical data packet structure for transmission of data within the system of FIG. 1,

FIG. 3 shows a modified bus packet format for use in the system of FIG. 1,

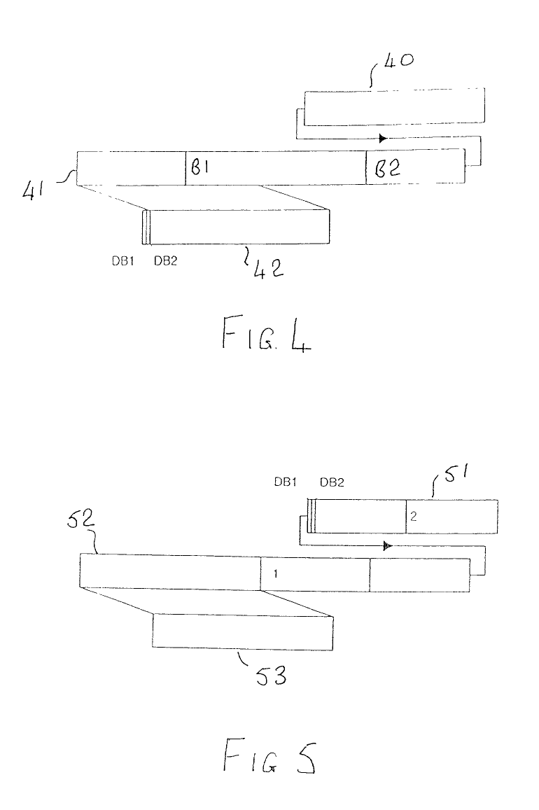

FIG. 4 shows a buffer memory arrangement for receiving data from one bus and transmitting it onto the bus to which it is connected, and

FIG. 5 shows a buffer memory arrangement for receiving data from the bus to which it is connected and transmitting it to a further bus.

Isochronous data streams have the requirement that they must flow substantially steadily, usually because they carry data that will be used by applications that present information in real time, such as audio or video programmes. Buses have advantages in certain kinds of environments and patterns of use. In particular, they offer flexibility of connection and in utilisation of the communication capacity. This flexibility tends to conflict with the requirements of isochronous data streams.

As is known this problem can be overcome by arranging that the time on such a bus has a rhythm in the form of a cycle or frame structure. A steady flow can be approximated by arranging that a suitably sized block of information is offered to the bus in each frame or cycle. Ideally the size of the block should be identical in each cycle but the unpredictability of source stream data rates and the requirement to dimension the blocks in terms of bits, bytes, or even larger data units usually precludes this. In practice, there may be some small variability in the size of the data block from cycle to cycle but the jitter this introduces can be smoothed by simple means.

For the purposes of management of the bus each data packet contains headers and, if data verification is required, trailers to the data blocks. Using buses that operate in bit serial mode to connect various pieces of equipment gives the advantage that the connecting cables need comparatively few conductors. Equivalent wireless networks also tend to use bit serial transmission, as only a single channel is then required.

The carriage of an isochronous data stream over one such serial bus is straightforward. The bandwidth required for the source stream is translated into a packet payload size for every bus cycle so that the product of the payload size and cycle rate is the stream rate, with allowance for packet overhead and possibly some rounding to deal with discrete data unit sizes. Arrangements are then made to ensure that the corresponding space is available on the bus during each cycle. The source, or sending device, then offers the packets to the bus in each successive cycle and they are retrieved by the sink, or receiving device, where the original data stream is reconstituted.

More complicated networks can, in principle, be made by linking several such buses together. If such networks are to support the carriage of isochronous data streams all the elements of the end to end connection must offer the same guaranteed bandwidth and must be able to manage the packet and cycle or frame structure. As has been stated before this could be achieved by ensuring the buses are synchronised so that the packets pass through the network with proper regularity. The present invention, however, provides a different solution to this requirement. This is based on the recognition that even when synchronisation is not achieved the disparity of cycle or frame rates in practical bus systems is small and variation in the packet rate from bus to bus can be compensated by repackaging the data so that the product of packet payload size and packet rate is constant in the long term.

FIG. 1 shows in block schematic form a plurality of buses 1, 2, and 3 which are interconnected by links 4 and 5. In this example, there are three interconnected bus systems but this is not essential and by using the present invention it is possible to interconnect a greater or lesser number of buses. The links 4 and 5 may be either of wired or wireless form; the actual transmission medium is unimportant in implementing the invention.

Each bus has connected thereto a number of data sources and data sinks and an interface unit that controls the transmission of data between the buses. As shown in FIG. 1 the bus 1 has an interface unit I₁ that communicates over the link 4 with an interface unit I₂ on the bus 2. The bus 2 also has a further interface unit I₃ connected to it which is arranged to transmit data packets from the bus 2 via the link 5 to an interface unit I₄ connected to the bus 3. In describing this embodiment of the invention, it will be assumed that data is to be transmitted from a source 10 on bus 1 to a sink 30 on bus 3. The buses 1, 2, and 3 have the same nominal cycle rates but are not synchronised with each other. Consequently, small differences in cycle rate may be present between them. The magnitude of these differences will depend on the bus specification and the maximum permissible differences can be established by calculations based on the bus specifications. Further, the start of a cycle on one bus will not, in general, coincide with that on another bus.

FIG. 2 shows a typical packet structure for transmitting data over a data bus. As shown, the data packet comprises a first header portion 20, a second portion 21 that indicates the packet length, and a third portion 22 that is a continuation of the packet header. A fourth portion 23 is the data payload, a fifth portion 24 contains justification padding, and a sixth portion 25 contains error detection and/or correction data. In practice, the second portion 21 will be part of the overall header portion that comprises portions 20, 21 and 22. It has been separated out to indicate the presence of a portion that indicates the length of the data payload in the packet. As has been disclosed above the payload may vary slightly from cycle to cycle because the size of data elements may prevent the same number being accommodated in each packet payload.

It has been appreciated that it is not necessary that the isochronous packets on a bus have the same size data payload. If flexibility is allowed in this parameter then small differences in rhythm across the network can be compensated by small cycle to cycle variations in isochronous data packet payloads. In order to ensure isochronous transmission it is necessary to reserve sufficient capacity to accommodate the highest possible speed source stream on the slowest bus. In the complementary set of circumstances, it will be apparent that a small amount of the bus capacity will be wasted. In theory, the determination of the required capacity could be accomplished by observation of the cycle rates of each of the interconnected buses over a sufficient period of time. It is, however, presently considered that the capacity determination is best carried out using the allowable tolerances on cycle rates specified by the particular standard according to which the bus system operates.

It will be apparent that in order to implement the invention the original or primary data packet, that is the one placed on the bus 1 by the source 10, has to be broken into pieces and distributed among other packets. In this particular implementation the packet receivers identify the positions of the original packet boundaries so that the original packets can be reassembled. A simple additional field in the packet header enables this to be accomplished. FIG. 3 illustrates the revised packet format. FIG. 3 shows the structure of the data packet including a bus management header BMH, a bus management trailer BMT, a field DB1 that is a pointer to the boundary, within the data payload of the packet, between the data payloads of two primary data packets Pₙ and Pₙ₊₁, and a second additional header field DB2 contains a numerical value that represents the length of the data payload of the primary data packet that occupies the second part of the data packet. This is an optional field and is intended to improve the maintenance of continuity if a packet is lost. In this way, it would be possible to preserve the original packet boundaries if one packet is lost. It will be appreciated that the data payload of each packet apart from the primary data packet may contain data from the data payload of more than one primary data packet. Recovery of lost data would be the responsibility of the originator of the data, that is either by the sink signalling to the source or by appropriate redundancy in the original transmitted data.

FIG. 4 shows the buffers necessary to repackage the primary data packet as received by interface unit I₂ from bus 1 via link 4. As soon as a primary data packet has been received over the link 4 it is placed in a receive buffer 40. Then as soon as there is room for it in a FIFO 41 it is transferred into the FIFO 41 to occupy the appropriate space and a pointer is updated. Again, as soon as possible enough data is taken from the output of the FIFO to create together with the values DB1 and DB2 a full packet payload as defined on bus 2. This packet payload is placed in a send buffer 42 and then read out onto the bus 2 at the appropriate time in the bus cycle. The values of DB1 and DB2 are calculated from the pointer values, which are updated as the data moves along the FIFO 41. In FIG. 4 the boundaries between received packets entered into the FIFO 41 from the receive buffer 40 are shown referenced B1 and B2. Thus, the first pointer specifies the position B1 which marks the start of the received packet payload and the second pointer specifies the position B2 which marks the end of the received packet payload. Under certain circumstances the FIFO 41 may hold less than the full nominal amount of data when the bus 2 requires it, that is at the appropriate time in the bus cycle, and a short packet will then be sent. This will occasionally occur when the cycle time of the second bus (or any succeeding bus) is shorter than that of the first bus.

The size of the buffers depends on whether they are provided as dedicated memory or whether they can be mapped on to general purpose RAM. In the first case they need to be large enough to accommodate the largest data units that are ever possible. These values are calculable, bounded, and, in practice, of reasonable size. In the second case they can be allocated session by session. They must be large enough to accommodate the data units for the current session and again these values are calculable. The FIFO 41 must be large enough to hold two complete data units plus the discrepancy between the maximum and minimum possible sizes as determined by the tolerance on the bus cycle rate. The number of pointers required will, in general, be two, but it is theoretically possible for the FIFO 41 in certain circumstances to contain three primary data unit boundaries.

As can be seen from FIG. 1, the bus 2 has two interface units I₂ and I₃. FIG. 5 shows the buffers required to reconstitute the primary data unit for transmission over the link 5 to the bus 3. A receive buffer 51 receives a bus 2 data unit together with the values DB1 and DB2. These data units will be received at the cycle rate of bus 2. This data unit is transferred to a FIFO 52 the output of which coincides with the leading edge of the original primary data unit, as put on to the bus 1 by the source 10. The value DB1 is used to update a pointer that identifies the end of the primary data unit. As soon as possible the primary data unit is transferred to a send buffer 53 for transmission to bus 3 over the link 5. The remaining data unit fragment in the FIFO is shifted to the output end and the next data unit from the receive buffer 51 is concatenated with it and the pointers are updated using the values DB1 and DB2.

It will be noticed that the data packet transmitted over the link 5 is identical to the primary data packet put onto the bus 1 by the source 10. The bus 3 has an interface unit I₄ that is of the same form as the interface unit I₂ of bus 2 and consequently the sink 30 will receive data packets of the form shown in FIG. 3. Thus it will receive the data at the cycle rate of bus 3 and the data packets will contain a data payload which ensures that the data is received at the same rate as transmitted by the source 10. It will be apparent that the bus 3 could be connected to a further bus system by including a further interface unit of the same form as the interface unit I₃ in bus system 2. At each transfer from bus to bus the primary data unit is reassembled for onward transmission.

The link layer packets on the various buses may have to be padded so that they conform to the relevant definitions, but this aspect of the data format is managed within the link layer and does not affect the recovered data units as described above. The provision for error recovery is confined to the possibility of recognising that a single isolated payload has been lost and allowing for the temporal sequence to be maintained. It does not enable the missing data symbol values to be recovered. This is the responsibility of the higher level layers of the system.

From reading the present disclosure, other modifications will be apparent to persons skilled in the art. Such modifications may involve other features which are already known in the design and use of data communications systems and component parts thereof and which may be used instead of or in addition to features already described herein.

1. A method of communicating isochronous data from a source attached to a first serial bus to a sink attached to a second serial bus, said first and second buses operating cyclically with similar but unsynchronised cycle periods, the method comprising the steps of determining the tolerances with respect to frequency between the first and second bus cycle periods, assembling the data for transmission into packets, allocating to said packets a variable size data payload dependent on the tolerances, including within the packets a header indicating the size of the payload, receiving the packets at the data sink, and extracting the data payload from the packets using the packet header indication of the size of the data payload.

2. A method as claimed in claim 1, comprising the steps of receiving data packets transmitted from the first bus at the second bus, entering the received packets into a received packets register, transferring each received packet into a first in first out (FIFO) memory when sufficient space exists in said FIFO memory, reading out output data packets from said FIFO memory at the cycle rate of the second bus, said output packets containing a data payload which is chosen to keep the average contents of the FIFO memory substantially constant.

3. A method as claimed in claim 2, comprising the further step of including in the data payload a code indicating the end of the data contained within the received packet whose data payload forms the initial part of the data payload of the output data packet.

4. A method as claimed in claim 3, comprising the steps of receiving output data packets from the second bus, reassembling them into data packets as received from the first bus, and transmitting the reassembled packets to a third bus operating cyclically with similar cycle periods to the first and second buses but not being synchronised with either of the other buses.

5. A method as claimed in claim 3, including the step of inserting into the data payload of the output data packet a code indicating the length of the data payload of data received in a received data packet subsequent to the received data packet whose data payload occupies the initial portion of the data payload of the output data packet.

6. A method as claimed in claim 4, including the step of inserting into the data payload of the output data packet a code indicating the length of the data payload of data received in a received data packet subsequent to the received data packet whose data payload occupies the initial portion of the data payload of the output data packet.

7. A communications network for communicating isochronous data comprising first and second buses, one or more data sources connected to the first data bus, one or more data sinks connected to the second data bus for receiving isochronous data from the data source, each data bus having similar but unsynchronised cycle periods said communications network further comprising a first interface arrangement connected to said first bus, said first interface arrangement comprising a packet assembly arrangement which assembles at the cycle rate of the first bus data packets comprising a header portion and a data payload portion, the header portion including data defining the length of the payload portion, and an output from which the data packets can be transmitted to a second interface arrangement connected to said second bus, said second interface arrangement comprising a buffer memory arrangement which receives the data packets sent by the first interface arrangement, separates the data payload from the data packet, reassembles data packets at the cycle rate of the second bus in such a manner that the quantity of data in the buffer memory kept substantially constant by varying the quantity of data in the payload of the data packet, and applies the reassembled data packets to the second bus.

8. A communications network as claimed in claim 6, in which said second interface arrangement comprises means for inserting data, which defines the end of the data payload of the received data packet which occupies the first part of the data payload of the reassembled packet, into the reassembled data packet within the data payload of the reassembled data packet.

9. A communications network as claimed in claim 7, in which said second interface arrangement further inserts data representing the length of the data payload of the next received packet.

10. A communication network as claimed in claim 8, comprising a third interface arrangement arranged to receive data packets from said second bus for transfer to a third bus, said third interface arrangement comprising a packet received register for receiving data packets from the second bus, a FIFO into which the received packets are transferred when space is available for them, and a packet reassembler which uses the data indicating the end of received packets to reassemble for transfer to the third bus data packets identical to the data packets transmitted from the first bus.

11. A communication network as claimed in claim 9, comprising a third interface arrangement arranged to receive data packets from said second bus for transfer to a third bus, said third interface arrangement comprising a packet received register for receiving data packets from the second bus, a FIFO into which the received packets are transferred when space is available for them, and a packet reassembler which uses the data indicating the end of received packets to reassemble for transfer to the third bus data packets identical to the data packets transmitted from the first bus.

12. A data bus arrangement including an input interface arrangement for receiving data packets from another data bus having a similar but unsynchronised cycle period, said input interface arrangement comprising a buffer memory arrangement which receives the data packets from the other bus, said data packets having a header portion including an indication of the data payload in the data packet, said interface arrangement being operative to separate the data payload from the data packet, reassemble data packets at the cycle rate of the bus in such a manner that the quantity of data in the buffer memory is kept substantially constant by varying the quantity of data in the payload of the data packet, and apply the reassembled data packets to the second bus.

13. A data bus arrangement as claimed in claim 12, wherein the reassembled data packet includes data indicating the boundary, within the data payload of the reassembled packet, of the data payload in the received data packet which forms the first portion of the data payload of the reassembled packet.

14. A data bus arrangement as claimed in 13, wherein the reassembled data includes data indicating the size of the data payload of the received data packet that starts from the end of the data payload of the first received data packet.

15. A data bus arrangement as claimed in claim 13, including an output interface arrangement for receiving data packets from the bus and transmitting them to a further data bus having a similar but unsynchronised cycle period, said output interface arrangement comprising a receive buffer memory in which the data payload from a received data packet is stored, an output FIFO into which the data payload is transferred when space is available, a packet reassembler which uses the data within the data payload indicating the boundary of the payload in the data packet received from the other bus to produce a data packet having the same data payload as that of the data packet received from the other bus, and transmission means for transmitting the reassembled data packet to the further data bus.
